(19) United States
(12) Patent Application Publication
(10) Pub. No.: US 2025/0378010 A1
(43) Pub. Date: Dec. 11, 2025

(54) Systems and Methods for Centralized Testing of Software

(71) Applicant: Uber Technologies, Inc., San Francisco, CA (US)

(72) Inventors: Arnav Balyan, Gurgaon (IN); Kartik Bommepally, Bengaluru (IN); Nimesh Khandelwal, Bengaluru (IN); Amruth Sampath, Bengaluru (IN); Kalyan Sivakumar, Bengaluru (IN)

(21) Appl. No.: 18/737,014

(22) Filed: Jun. 7, 2024

(51) Int. Cl. G06F 11/36; G06F 8/656

(52) U.S. Cl. CPC G06F 11/3668; G06F 8/656

(57) ABSTRACT

Systems and methods for centralized testing of software. The system can access change data indicative of at least one change to an implemented version of software, wherein: (i) the change is associated with a first computing environment and the implemented version of software is associated with a second computing environment, and (ii) the change data is associated with a request to test the change against the implemented version of software. The method can include generating an isolated computing environment to test the change against the implemented version of software, wherein generating an isolated computing environment includes determining one or more datasets that are relevant to the at least one change. The method can include testing, within the isolated computing environment, the change against the implemented version of software. The method can include migrating the change from the first computing environment to the second computing environment.

### FIELD

The present disclosure generally relates to techniques for testing computer software.

### BACKGROUND

New versions of software can introduce new functionality or features, fix bugs, and address vulnerabilities. However, software should first be tested and validated prior to implementation. Furthermore, updating software can cause challenges such as downtime and addressing software or automation dependencies.

### SUMMARY

Aspects and advantages of embodiments of the present disclosure will be set forth in part in the following description, or may be learned from the description, or may be learned through practice of the embodiments.

In an example aspect, the present disclosure provides an example computer-implemented method. The example computer-implemented method includes accessing change data indicative of at least one change to an implemented version of software, wherein (i) the at least one change is associated with a first computing environment and the implemented version of software is associated with a second computing environment, and (ii) the change data is associated with a request to test the at least one change against the implemented version of software. The method includes generating an isolated computing environment to test the at least one change against the implemented version of software, wherein generating an isolated computing environment includes determining one or more datasets that are relevant to the at least one change. The method includes testing, within the isolated computing environment, the at least one change against the implemented version of software. The method includes migrating the at least one change from the first computing environment to the second computing environment.

In some implementations, generating an isolated computing environment includes determining a plurality of applications associated with the at least one change, wherein at least one application of the plurality of applications is directly impacted by the at least one change.

In some implementations, the plurality of applications associated with the at least one change are associated with at least one of: (i) input data inputted into the at least one application or (ii) output data produced by the at least one application.

In some implementations, determining one or more datasets includes accessing a catalog comprising information indicative of at least one of: (i) a read operation to read data, or (ii) a write operation to write data to at least one location associated with a dataset.

In some implementations, the method includes parsing one or more queries associated with the one or more datasets to determine metadata associated with one or more data operations that interact with the one or more datasets.

In some implementations, testing within the isolated computing environment includes executing at least a portion of the at least one change and the implemented version of software to perform at least one of: (i) read data from a first dataset, (ii) process data from the first dataset, or (iii) write data to a second dataset.

In some implementations, the method includes validating the data written to the second dataset by comparing the second dataset to a previous dataset associated with the implemented version of software.

In some implementations, the second dataset is ephemerally stored within the isolated computing environment.

In some implementations, the second dataset is associated with a context identifier, wherein the context identifier identifies the second dataset for subsequent testing requests.

In some implementations, the method includes receiving one or more subsequent requests to test a change associated with the second dataset. In some implementations, the method includes executing at least a portion of the change associated with the second dataset to read data from the second dataset.

In some implementations, the method includes generating metric data associated with a performance of the at least one change, the metric data indicative of at least one of: (i) computing efficiencies or (ii) new features generated as a result of migrating the at least one change to the second computing environment.

In some implementations, the method includes, in response to testing the at least one change, detecting an error. In some implementations, the method includes transmitting error data describing the error to a remote computing system.

In another aspect, the present disclosure provides an example computing system. The example computing system includes one or more processors and one or more non-transitory, computer readable medium storing instructions that are executable by the one or more processors to cause the computing system to perform operations. The example operations include accessing change data indicative of at least one change to an implemented version of software, wherein (i) the at least one change is associated with a first computing environment and the implemented version of software is associated with a second computing environment, and (ii) the change data is associated with a request to test the at least one change against the implemented version of software. The example operations include generating an isolated computing environment to test the at least one change against the implemented version of software, wherein generating an isolated computing environment includes determining one or more datasets that are relevant to the at least one change. The example operations include testing, within the isolated computing environment, the at least one change against the implemented version of software. The example operations include migrating the at least one change from the first computing environment to the second computing environment.

In some implementations, generating an isolated computing environment includes determining a plurality of applications associated with the at least one change, wherein at least one application of the plurality of applications is directly impacted by the at least one change.

In some implementations, the plurality of applications associated with the at least one change are associated with at least one of: (i) input data inputted into the at least one application or (ii) output data produced by the at least one application.

In some implementations, determining one or more datasets includes accessing a catalog comprising information indicative of at least one of: (i) a read operation to read data, or (ii) a write operation to write data to at least one location associated with a dataset.

In some implementations, the operations include parsing one or more queries associated with the one or more datasets to determine metadata associated with one or more data operations that interact with the one or more datasets.

In some implementations, testing within the isolated computing environment includes executing at least a portion of the at least one change and the implemented version of software to perform at least one of: (i) read data from a first dataset, (ii) process data from the first dataset, or (iii) write data to a second dataset.

In some implementations, the operations include validating the data written to the second dataset by comparing the second dataset to a previous dataset associated with the implemented version of software.

In another example aspect, the present disclosure provides for one or more example non-transitory computer-readable medium storing instructions that are executable to cause one or more processors to perform operations. The example operations include accessing change data indicative of at least one change to an implemented version of software, wherein (i) the at least one change is associated with a first computing environment and the implemented version of software is associated with a second computing environment, and (ii) the change data is associated with a request to test the at least one change against the implemented version of software. The example operations include generating an isolated computing environment to test the at least one change against the implemented version of software, wherein generating an isolated computing environment includes determining one or more datasets that are relevant to the at least one change. The example operations include testing, within the isolated computing environment, the at least one change against the implemented version of software. The example operations include migrating the at least one change from the first computing environment to the second computing environment.

Other example aspects of the present disclosure are directed to other systems, methods, apparatuses, tangible non-transitory computer-readable media, and devices for performing functions described herein. These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example computing ecosystem according to example aspects of the present disclosure.

FIG. 2 depicts an example data flow pipeline according to example aspects of the present disclosure.

FIG. 3 depicts an example architecture diagram according to example aspects of the present disclosure.

FIG. 4 depicts an example data flow pipeline according to example aspects of the present disclosure.

FIG. 5 depicts an example data flow pipeline according to example aspects of the present disclosure.

FIG. 6 depicts an example data flow pipeline according to example aspects of the present disclosure.

FIG. 7 depicts an example flowchart diagram of an example method according to example aspects of the present disclosure.

FIG. 8 depicts an example computing ecosystem according to example aspects of the present disclosure.

### DETAILED DESCRIPTION

Generally, the present disclosure is directed to techniques for testing of software. More particularly, techniques according to the present disclosure provide a framework for centrally testing new versions of software and testing individual software changes that may impact one or more interdependent software applications. The processes described herein help to reduce complexity and time needed to implement impactful software changes (e.g., software changes that impact other applications, etc.) and update software more quickly to take advantage of new features or capabilities. The process described also helps reduce outages or other disruptions resulting from inadequately tested software, thereby increasing the reliability of a computing system. The system of the present disclosure can isolate software changes and utilize production data to test and validate the change without impacting the normal operations of the computing system.

For example, enterprise software (e.g., enterprise application software (EAS)) includes software which may be implemented and utilized across multiple applications and systems within an enterprise computing system (ES). The EAS may be used by various applications within the ES to provide services or perform tasks relevant to the specific function of the ES. For instance, a logging EAS may be implemented across various systems within an ES and configured to generate different types of logs that are relevant to respective enterprise teams. The EAS may also be implemented using a specific version and may be modified accordingly to optimize its applicability in the various contexts and use cases across the ES. This may create complex challenges when attempting to centrally update the EAS to a new version across the ES due to the use-case specific implementations or modifications. For instance, testing a new version of the EAS against each implemented use case can be complex, costly, and time consuming. The issue is compounded by interdependencies between various applications within the ES. For instance, a new software version of an EAS may cause issues for an upstream application (e.g., an application that the EAS depends on or receives data from) or a downstream application (e.g., an application that depends on the EAS or receives data from the EAS) through data changes introduced by the new software version.

To address this problem, embodiments of the present disclosure include a computing system that generates an isolated computing environment to test changes (e.g., version updates, individuals code changes, etc.) to EAS using production data. The isolated computing environment may be ephemeral and generated in response to a detected software change. For instance, the system can access change data indicating that a change to an implemented version of the EAS is available. The change data can be the result of a new release of open-sourced software (e.g., open-sourced EAS), Commercial-Off-The-Shelf (COTS) software, or changes to any other type of software implemented across a portion of an ES. In an embodiment, the change may be staged for testing in a first computing environment (e.g., staging, quality assurance (QA), etc.). For instance, untested changes introduced into a second computing environment (e.g., production, live, etc.) may cause unforeseen issues or errors.

To test the change, the system may generate an isolated computing environment. The isolated computing environment may be separate from the first computing environment and the second computing environment. The isolated computing environment may be configured to remotely read data from the second computing environment (e.g., production, live, etc.) and write data to the isolated environment to test the change without impacting the second computing environment. For instance, the system may determine one or more datasets that are relevant to the change. To determine datasets relevant to the change, the system may access a catalog indicating relationships between the various applications within the ES and the data that they interact with. The datasets may be production datasets that are used by the currently implemented version of the EAS within the second computing environment.

The isolated computing environment may include one or more servers configured to execute at least a portion of software associated with an application. For instance, a data-analytics EAS may be implemented across a plurality of applications within an ES. The system may test a new version (e.g., EAS software change, etc.) of the data-analytics EAS using a first application. As such, at least a portion of the software associated with the first application and the associated EAS change (e.g., version update, etc.) may be run on one or more servers within the isolated computing environment. The computing system may test the first application including the change by performing read operations to retrieve or otherwise access data from the datasets associated with the second computing environment (e.g., production data). The first application may process the production data with the change applied and perform a write operation to create, update, or otherwise output data to a dataset stored within the isolated computing environment. In this way, the first application may test the new version (e.g., change) for breaking changes to the EAS using production data without impacting the normal operations of the second computing environment. A breaking change may include one or more changes to a portion of a codebase that “break” the code or otherwise prevent the code from executing.

In an embodiment, the change may be tested for data validation. For instance, the dataset output as a result of the write operation and stored within the isolated computing environment may be validated by comparing it against a production dataset generated by the first application within the second computing environment (e.g., production environment without the change). The computing system may compare the two datasets for anomalies, errors, or other aspects to determine whether errors are produced as a result of the change.

In another embodiment, the first application may be associated with one or more dependent applications. Dependent applications may include upstream or downstream applications which may directly or indirectly interact with the dataset used to test the change with the first application. The computing system may generate a context identifier associated with the dataset stored in the isolated environment to test the validity of the change and/or validity of the data. For instance, a second application running in a second isolated computing environment may perform a read operation on the dataset stored within the first isolated computing environment and test the second application for potential errors or impacts. In this way, the computing system may also test the upstream and downstream impacts of a change to EAS. For instance, the second application may also include an implemented version of the EAS to be tested.

Once the computing system has determined there are no errors associated with the processing of the applications that have applied the change and there are no data validation issues, the computing system may merge the change. Merging the change may include updating the second computing environment to include the change to the EAS software from the first computing environment.

The technology of the present disclosure may provide several benefits and technical effects. For instance, the technology of the present disclosure automates the testing and validation of enterprise software by programmatically testing changes in an isolated environment. As such, the technology may increase the overall stability, performance, and reliability of the application system by limiting the probability of incidents or outages due to untested changes. The technology of the present disclosure may also help to increase the flexibility of application systems without impacting performance due to the increase in adoption or implementation of new features. Moreover, by reducing the increasing the flexibility of the computing system, the technology of the present disclosure may increase security of the computing system by enabling faster responses to vulnerabilities or other security threats.

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations may be made to the embodiments without departing from the scope of the present disclosure. For instance, features illustrated or described as part of one embodiment may be used with another embodiment to yield a still further embodiment. Thus, it is intended that aspects of the present disclosure cover such modifications and variations.

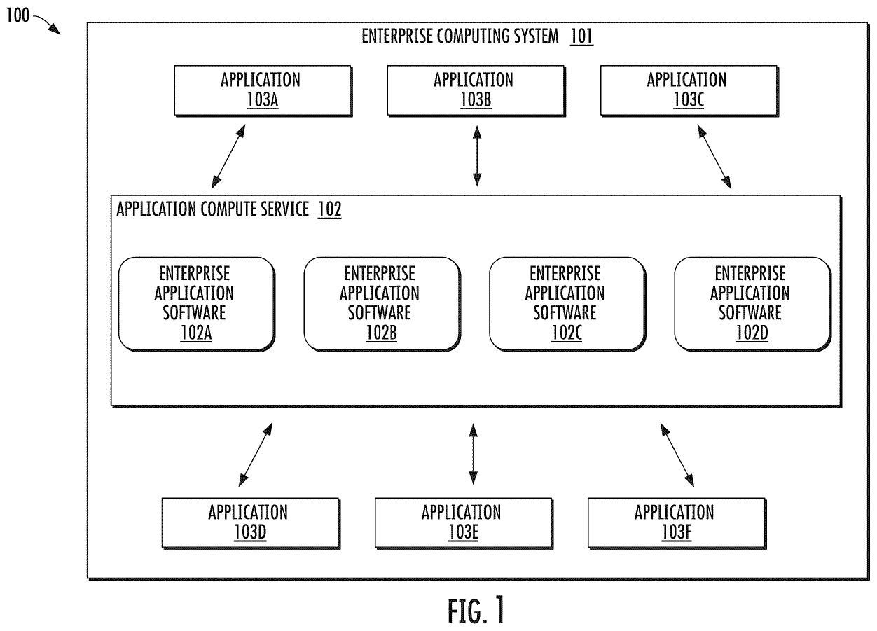

FIG. 1 depicts an example computing ecosystem according to example aspects of the present disclosure. The example computing ecosystem 100 may include an enterprise computing system 101 comprised of a plurality of applications 102A-F. The plurality of applications 103A-F may access an application compute service 102 to retrieve or otherwise access enterprise application software 102A-C that has been made available to the plurality of applications 103A-F. The application compute service 102 may be configured to distribute various enterprise application software 102A-D across the enterprise computing system 101 to the applications 103A-F and manage the complexities of running enterprise application software 102A-D at scale.

With respect to examples as described herein, the system 100 may be implemented on a server, combination of servers, or a distributed set of computing devices which communicate over a network such as the Internet. For example, the system 100 may be distributed using one or more physical servers, virtual private servers, or cloud computing. In other examples, the system 100 may be implemented as a part of or in connection with a microservices architecture, where, for example, the plurality of applications 103A-F are associated with independent services (e.g., microservices, etc.) that collectively make up a distributed application (e.g., enterprise computing system 101). The independent services may communicate with each other over one or more networks such as the internet.

The enterprise computing system 101 may be a system associated with an entity or an identifiable organization. For instance, the enterprise computing system 101 may be associated with a service provider entity that provides products or services. The enterprise computing system 101 may include internal servers, data storage, internal networks (e.g., server-to-server communications), firewalls, etc. that enable the enterprise computing system 101 to facilitate both internal communications (e.g., amongst applications 103A-F, etc.) and external communications (e.g., remote computing system, etc.) securely over a network. The enterprise computing system 101 may be implemented in a cloud environment (e.g., private cloud, public cloud, etc.), on-premise in one or more data centers, or a combination of both. The enterprise computing system 101 may be configured to implement specific security protocols which prevent unauthorized (e.g., external, etc.) access to internal servers or data. While examples, herein describe an enterprise computing system 101 as being associated with an entity, the present disclosure is not limited to such embodiment and may be implemented on any computing system which runs software.

The enterprise computing system 101 may include a plurality of applications 103A-F that serve various functions for the enterprise computing system 101 to meet and solve business requirements. In an embodiment, the applications 103A-F may include or otherwise run on servers, clients, or any combination thereof. The applications 103A-F may include software configured to perform one or more tasks associated with a particular function of the enterprise computing system 101. In an embodiment, the enterprise application software 102A-D may be custom built software, open-sourced software, COTS software, etc. For instance, the applications 103A-F may include software code written internally (e.g., custom software) or third-party software purchased or otherwise implemented to address a business need. While examples herein describe applications 103A-F as being within a single enterprise computing system 101, the present disclosure is not limited to such embodiment and may be implemented across any combination of internal and external applications that interact with the same datasets.

In an embodiment, the applications 103A-F may communicate internally (e.g., with each other) to create, process, or otherwise interact with data. For instance, the applications 103A-F may transmit data across the enterprise computing system 101 via API calls, RPC (remote procedure calls), WebSocket, Event-Driven communications, etc.

By way of example, application 103A may be associated with marketing function of the entity (e.g., service provider, etc.). For instance, application 103A may include software configured to aggregate an end user dataset associated with users of the entity's products or services for marketing purposes. In an embodiment, application 103E may routinely access, process, or interact with the same end user dataset as for accounting or financial purposes. For example, application 103E may be associated with a finance function responsible for collecting payments from end users of the entity. In an embodiment, application 103A and application 103E may interact (e.g., via API calls, etc.) with each other resulting in a read or write operation to occur on the same end user dataset. For instance, an end user may respond to a marketing campaign based on one or more processes facilitated by application 103A and provide user contact information. In response to receiving the user's contact information, application 103A may write (e.g., store) the user's contact information within the end user dataset and call (e.g., API call, etc.) the application 103E to facilitate the creation of a financial or accounting profile for the user. In an embodiment, application 103E may read (e.g., read operation) the user's contact information from the end user dataset and process it further to create the accounting profile.

In another embodiment, application 103B, application 103C, and application 103D may all read data from the same data set. By way of example, application 103B may be associated with a human resources function of the entity, application 103C may be associated with a sales function of the entity, and application 103 D may be associated with a research and development function of the entity. Each of the respective applications 103B-D may access an employee data set which facilitates employee credentials for authenticating with an internal network of the enterprise computing system 101. For instance, application 103F may be associated with an information technology (IT) or security function of the entity and maintain an employee data set which applications 103B-D access to authenticate and authorize employees for the respective applications 103B-D. As such applications 103B-D may routinely read employee data from the employee data by either calling (e.g., APIs, etc.) application 103F or directly reading from a published dataset.

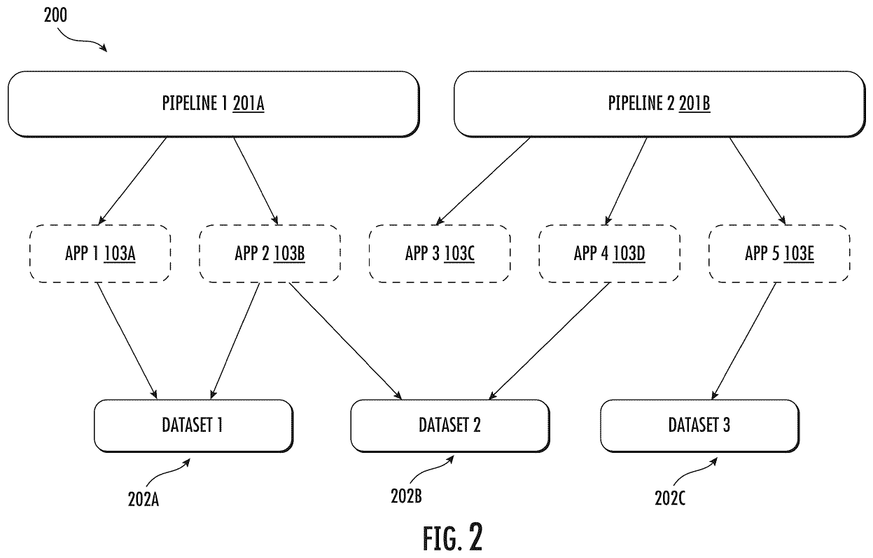

In this way the continuous interactions amongst the plurality of applications 103A-F with shared datasets can cause upstream and downstream applications 103A-F to be impacted (e.g., directly or indirectly) if one of the applications 103A-F is experiencing an error and/or outputs corrupted data that is relied upon by other applications or systems. An example of the complexity presented by a plurality of applications 102A-F interacting with the shared datasets using enterprise application software 102A-D is further described with reference to FIG. 2.

The enterprise computing system 101 may include an application compute service 102 configured to facilitate running enterprise application software 102A-D at scale. The application compute service 102 may include software running on one or more servers of the enterprise computing system 101. The application compute service 102 may serve as the central coordinator for all enterprise application software 102A-D. Enterprise application software 102A-D may include any software which is run in multiple instances or environments across a computing system (e.g., enterprise computing system 101). Example enterprise application software 102A-D may include, but is not limited to data analytics systems, email systems, business intelligence (BI) systems, content management systems, internal collaboration systems, etc.).

The application compute service 102 may maintain versions of the enterprise application software 102A-D including environment settings and configurations, such that the enterprise application software 102A-D is readily available to the applications 103A-F. For example, applications 103A-F which desire to utilize the enterprise application software 102A-D may request a particular enterprise application software 102A-D and receive a version of the enterprise application software 102A-D that may be implemented locally (e.g., at the application level). This allows respective applications 103A-F across the enterprise computing system 101 to utilize enterprise application software 102A-D through a customized implementation that satisfies the business needs of the respective functions (e.g., of the entity).

In an embodiment, the application compute service 102 may distribute the enterprise application software 102A-D and configure the environment for the enterprise application software to run. By way of example, all applications 103A-F may utilize enterprise application software 102B. For instance, enterprise application software 102B may be a data analytics software configured to provide the applications 103A-F with a distributed processing system that consumes big data workloads and offers optimized query execution for data analytics. The application compute service 102 may, in response to a request from one or more applications 103A-F, intelligently determine where (e.g., a compute cluster, application servers, etc.) the instance of the enterprise application software 102B should run. The application compute service 102 may inject a cluster-specific configuration (e.g., instructions defining the computing environment for the enterprise application software 102B) into a cluster (e.g., collection of servers, etc.), and provision the cluster on behalf of respective application 103A-F.

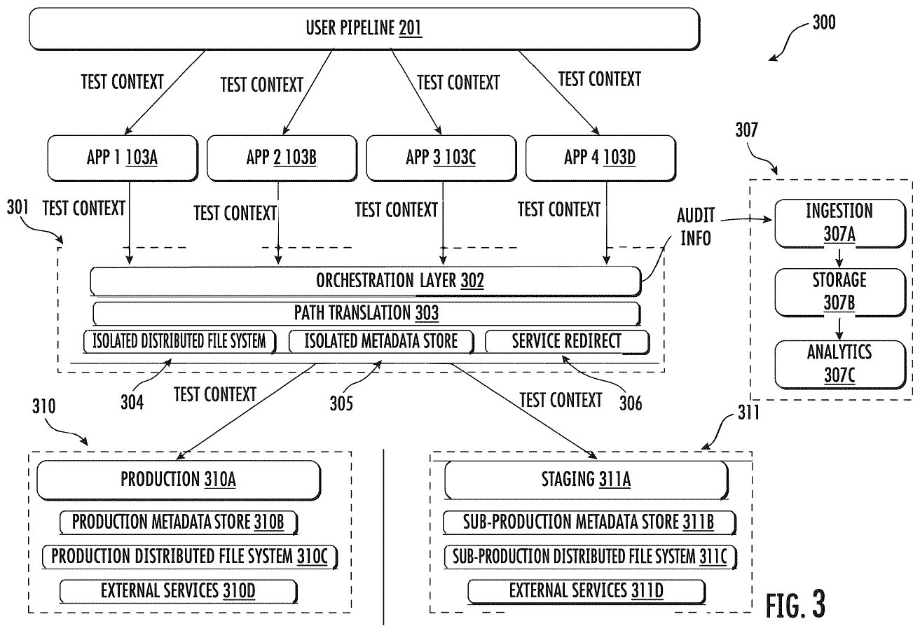

In this way, the application compute service 102 may centralize the provisioning and deprovisioning of enterprise application software 102A-D across the enterprise computing system 101. This allows for centralization of software version control (e.g., tracking and managing changes to software) across the enterprise computing system 101. In an embodiment, the application compute service 102 may maintain a registry of all applications 103A-F which utilize respective enterprise application software 102A-D and the version they are running. In another embodiment, the application compute service 102 may facilitate data transparency across the enterprise computing system 101. For instance, enterprise application software 102A-D that is centrally maintained and distributed across the enterprise computing system 101 may enable visibility all interactions that occur across the applications 103A-F. This may be used to generate a catalog indicating the interactions. The catalog may be referenced during testing to anticipate write operations and write data to an isolated computing environment to test new versions of software or software changes. An example catalog is further described with reference to FIG. 3.

The application compute service 102 may control the versions of enterprise application software 102A-D that are available to the applications 103A-F. For instance, the application compute service 102 may be used to update the enterprise application software 102A-D to newer versions. By way of example, enterprise application software 102C may include open-sourced software which has been analyzed and/or modified for internal (e.g., internal to the enterprise computing system 101) use. However, updating enterprise application software 102A-D may pose challenges due to its various uses and implementations across the applications 103A-F. For instance, updating the version of the enterprise application software 102A-D may require each application to test and validate the new version to avoid disruptions or outages. To address this problem, the new version may be staged in a sub-production environment for testing. In an embodiment, an isolated computing environment may be provisioned to test the applications 103A-F running the newer version of the enterprise application software. An example of an isolated computing environment is further described with reference to FIGS. 3-6.

FIG. 2 depicts an example dataflow pipeline according to example aspects of the present disclosure. The following description of dataflow pipeline 200 is described with an example implementation in which a plurality of applications 103A-E associated with an enterprise application software 102A-D interact with shared datasets 202A-C. Pipelines 201A-B may enable the applications 103A-E to operate (e.g., read, write, etc.) on the shared datasets in a staggered manner.

By way of example, applications 103A-E may respectively utilize (e.g., run an instance, etc.) enterprise application software 102B. For instance, enterprise application software 102B may be a data analytics software and allow the applications A-E to access shared datasets 202A-C to generate data analytics using data across all applications 103A-E. As such, the applications 103A-E may respectively perform read and write operations against the shared datasets 202A-C. However, allowing the applications 103A-E to read and write from the shared datasets 202A-C without any order or predetermined controls may result in concurrent updates that corrupt or distort the shared datasets 202A-C. Thus, enterprise application software 102B may utilize pipelines 201A-B to provide the applications 103A-E a way to interact with the shared datasets 202A-C in a staggered (e.g., sequential, etc.) manner. While examples herein describe a data analytics software test, the present disclosure is not limited to such embodiment and may be used to test any type of software.

Pipelines 201A-B may include computing instructions or configurations of the enterprise application software 102B which govern the interactions amongst the applications 103A-E with the shared datasets 202A-C. For instance, the pipelines 201A-B may include a specified sequence of stages that are run in order. The order may control the interactions with the shared datasets 202A-C such that read and write operations can occur without distorting or corrupting the shared datasets 202A-C.

As depicted in dataflow pipeline 200, the pipeline 201A may orchestrate the interactions of applications 103A-B with datasets 202A-B. For instance, pipeline 201A may include two sets of stages. For example, a first stage may include interactions associated with application 103A. In this example stage, application 103A may interact (e.g., read, write, etc.) with shared dataset 202A. In the second stage, application 103B may interact with shared dataset 202A and shared dataset 202B. Example interactions may include, but are not limited to read operations (e.g., retrieve, access, etc.), write operations (e.g., output, store, etc.), create operations (e.g., generate new files, etc.), copy operation (e.g., duplicate files, etc.), set attributes (e.g., modify metadata, etc.), or any other file operation. Pipeline 201A may ensure that the stages associated with applications 103A-B occur in a staggered or sequential manner.

Pipeline 201B may orchestrate similar stages of interactions with the shared datasets 202B-C. For instance, applications 103C-E may be associated with pipeline 201B. Pipeline 201B may include a stage where application 103C receives data or accesses data associated with the pipeline 201B, but does not perform any data operations on the shared datasets 202B-C. For example, application 103C may not be an enabled stage (e.g., not configured to run). In another embodiment, application 103C may be middleware (e.g., software used to integrate software components into other applications) which collects information from within the pipeline 201B, but does not interact with the shared datasets 202B-C. Pipeline 201B may also include a second and third stage where application 103D interacts with shared dataset 202B and application 103E interacts with shared dataset 202C.

In an embodiment, the pipelines 201A-B may be generated using the catalog of all interactions and paths associated with the shared datasets 202A-C across the applications 103A-E. For instance, a catalog, associated with the enterprise application software 102A-D may be referenced for test scenarios when testing new versions of the enterprise application software 102A-D. By way of example, an automated testing system may access the catalog of interactions between applications 103A-E and shared datasets 202A-C to test or simulate the interactions within an isolated environment using a new version of the enterprise application software 102A-D. An example of an automated testing system testing new versions of enterprise application software 102A-D within an isolated environment is further described with reference to FIG. 3.

FIG. 3 depicts an example architecture diagram according to example aspects of the present disclosure. The example architecture diagram 300 depicts an example implementation of an automated testing system 301 configured to facilitate the testing of enterprise application software 102A-D within applications 103A-D using a pipeline 201 across a first environment 311 and a second environment 310. The following description of architecture diagram 300 is described with reference to testing an example data analytics software (e.g., enterprise application software 102A-D) for example purposes only. The present disclosure is not limited to such embodiment and may be implemented to test any type of software.

The data analytics software may be implemented across multiple applications 103A-D within an enterprise computing system 101. For instance, the data analytics software may run multiple instances associated with each of the applications 103A-D to allow the applications 102A-D to interact with shared datasets (e.g., 202A-C) to generate data analytics.

As previously discussed, a pipeline 201 may include multiple applications 103A-D which can interact with the same datasets (e.g., datasets 202A-C). In an embodiment, these interactions within the pipeline 201 may be used as test scenarios to test new versions of the enterprise application software 102B in an isolated environment. For instance, an automated testing system 301 may be used to facilitate test runs of a new version of the data analytics software across the applications 103A-D by writing data to an isolated computing environment which does not impact the normal operations of the applications 103A-D (e.g., within the second computing environment 311).

As depicted in the example architecture diagram 300, the automated test system 301 may be positioned between the applications 103A-D, a first computing environment 311, and a second computing environment 310 to intercept data operations (e.g., read, write, etc.), provide isolated context for testing and redirect a portion of the data operations to an isolated computing environment. The first computing environment 311 may be associated with a sub-production environment or instance of the data analytics software. The second computing environment 310 may be associated with a production environment such as a staging, QA (quality assurance), or test environment.

The second computing environment 310 may include a production instance 310A, a production distributed metadata store 310B, a production distributed file system 310C, and production services 310D associated with the data analytics software. The production instance 310A may include a current version of the data analytics software which is currently implemented across the applications 103A-D, enterprise computing system 101, etc. The production distributed metadata store 310B may include a central repository of metadata associated with the shared datasets 202A-C that can be accessed and analyzed by the applications 103A-D to more efficiently search. The production distributed file system 310C may include a distributed storage system that allows applications 103A-D to read, write, and manage petabytes of data using SQL or other database languages. The production services 310D may include one or more external services (e.g., microservices, computing processes, etc.) which facilitate communications to external computing systems or services or provide access shared datasets 202A-C within the second (e.g., production) computing environment 310.

The first computing environment 311 may similarly include a sub-production instance 311A, a sub-production distributed metadata store 311B, a sub-production distributed file system 311C, and sub-production services 311D associated with the data analytics software. The first computing environment 311 may include a new or untested version of the data analytics software. For instance, the first computing environment 311 may be used to test codes, builds, and updates to ensure quality under a “production-like” environment before application deployment. However, the shared datasets (e.g., shared datasets 202A-C) stored within the first computing environment 311 may differ from the datasets stored in the second computing environment 310. For instance, the first computing environment 311 may utilize synthetic datasets to test codes, builds, and updates. While this configuration may allow for testing the software version, it does not allow for testing of data quality and validation. To address this problem, the automated testing system 301 may be used to test the codes, builds, updates, and/or data quality in an isolated computing environment as described herein.

For example, test context (e.g., change data) may be injected into the pipeline 201 identifying one or more test runs to test a new version of the data analytics software. By way of example, an administrator (e.g., products owner, etc.) associated with the application compute service 102 or the data analytics software (e.g., enterprise application software 102B) may trigger a test run of a new version of the data analytics software by injecting test context into the pipeline 201. Injecting test context may include staging the new version of the data analytics software in a sub-production environment or provisioning an isolated computing environment (e.g., private client, etc.). The test context may be created based on a test run initialized to test the new version. In an embodiment, test context may be injected programmatically (e.g., by detecting a new version is available, new pull request on a code branch, etc.). The test context may indicate the one or more portions of the data analytics software which are affected or changed by the new version. For instance, new versions of software may be tested and deployed in stages. The test context may indicate the specific changes that are to be applied to the applications 103A-D and subsequently tested by the automated testing system 301.

The test context may be injected into the data operations of the applications 103A-D. For instance, in response to staging the new version for testing, the pipeline 201 may coordinate the data operations of the applications 103A-D in a staggered manner and associate the data operations with the test context to indicate that particular data operations are associated with a test run. As the pipeline 201 facilitates the execution of the data operations across the applications 103A-D the data operations including the test context may pass through the automated testing system 301, where the data operations may be tested against the new version of the data analytics software using an isolated computing environment.

For example, the automated testing system 301 may include software running on one or more servers of the enterprise computing system 101. The automated testing system 301 may run alongside (e.g., within the same clusters, nodes, containers, etc.) the data analytics software. In an embodiment, the automated testing system 301 may be injected within the data analytics software itself. For instance, the automated testing system 301 may modify the pipeline 201 associated with the data analytics software such that the data operations (e.g., read, write, etc.) that the applications 103A-D perform on the datasets (e.g., shared datasets 202A-C) may be simulated (e.g., test runs, etc.) in an isolated computing environment to test new versions of the data analytics software. In some embodiments, the automated testing system 301 may utilize the first computing environment 311 to execute the new version (e.g., new release, code changes, etc.) of the data analytics software and utilize the isolated computing environment to validate the data. In other embodiments, the automated testing system 301 may be implemented remotely from the enterprise computing system 101. For instance, the automated testing system 301 may be implemented within a CI/CD (continuous-integration-continuous-deployment) system configured to manage software deployments within the enterprise computing system 101.

In an embodiment, the automated testing system 301 may also be configured to certify software deployments post-deployment. For instance, the automated testing system 301 may be configured to monitor performance of the applications 103A-D for failures and data quality issues to evaluate performance of the new version of the software.

The automated testing system 301 may include subsystems and components. For instance, the automated testing system 301 may include an orchestration layer 302, a path translation service 303, an isolated distributed file system 304, an isolated metadata store 305, and a redirect service 306. The isolated distributed file system 304 and the isolated metadata store 305 may perform similar functions to the production distributed file system 310C, sub-production distributed file system 311C, production metadata store 310B, and sub-production metadata store 311B respectively. The automated testing system 301 may be configured to simulate data operations which pass through, from the applications 103A-D, and write output data in an isolated computing environment using an isolated context. The automated testing system 301 may also generate metric data to review testing outcomes.

By way of example, the orchestration layer 302 may include software running on one or more servers within the automated testing system 301. The data operations from the applications 103A-D may pass through the orchestration layer 302 indicating test context for a particular version of the data analytics software. For instance, the test context (e.g., change data) may indicate the new version of the data analytics software that is being initialized for a test run within the pipeline 201. In response to the test context, the orchestration layer 302 may provision an isolated computing environment which runs an instance of the new version of the data analytics software. For instance, similar to the second computing environment 310 and the first computing environment 311, the isolated computing environment may include an isolated distributed file system 304 and an isolated metadata store 305 which will store resulting data from the simulated data operations that have passed through the orchestration layer 302. In an embodiment, the automated testing system may include one or more servers, clusters, etc. provisioned to run an instance of the new version of the software.

In another embodiment, the first computing environment 311 may host the new version of the data analytics software (e.g., on a private client, etc.) and data operations executed within the second computing environment may be stored within the isolated computing environment to preserve the integrity of the data. For instance, the new version may be staged within the first computing environment 311 and prohibited from writing within the second computing environment 311. As such all write operations may be written to the isolated computing environment.

As the data operations and the associated test context pass through the automated testing system 301, the data operations may be executed by the production instance 310A (e.g., running the current version) of the data analytics software. In this way, data analytics software may continue to operate while a new version is being tested. For instance, the data operations may generate a result or output which may be stored in an isolated computing environment.

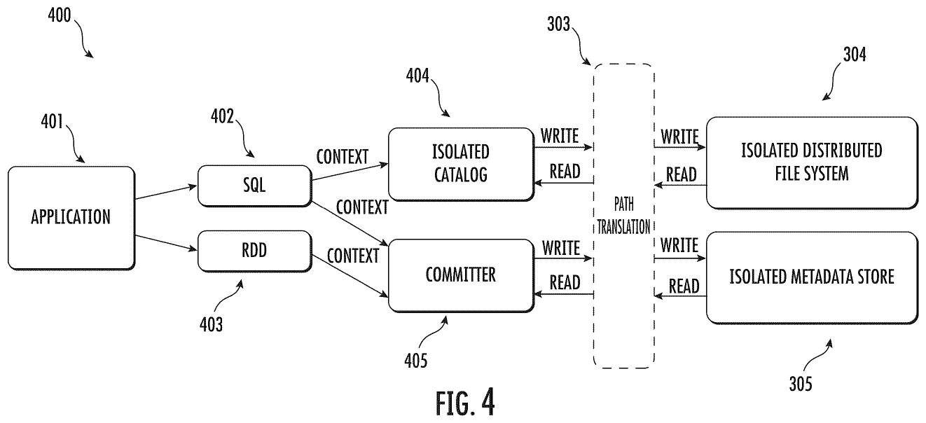

The path translation service 303 may translate the paths (e.g., path to the location of the dataset) of the data operations to govern new locations where data will be stored within the isolated distributed file system 304. For example, the table names for the newly generated data within the isolated metadata store 305 may be determined. The automated testing system 301 may be coupled or otherwise have access to the catalog (e.g., registry of data operations, etc.) indicating the data operations occurring within the pipeline 201. In response to the test context, the orchestration layer 302 may utilize the redirects service 306 to redirect all write operations (e.g., from the new version) to an isolated computing environment (e.g., isolated distributed file system 304) determined by the path translation service 303. In an embodiment, the automated testing system 301 may include an external catalog which enables additional creation of isolated storage locations (e.g., within the isolated distributed file system 304). An external catalog is further described with reference to FIG. 4.

The path translation service 303 may implement a unique naming convention using the test context (e.g., change data) to determine paths to an isolated storage location which may be associated with a location within the second computing environment 310 or the first computing environment 311. For instance, datasets can be available in the second computing environment 310, first computing environment 311, isolated computing environment, or all during read and write operations. While reading data, if staging data (e.g., data within the isolated computing environment, first computing environment 311, etc.) is available for the given test context, then staging data is selected. Because the isolated computing environment and second computing environments 311 are utilized for testing, staging data within the isolated computing environment or first computing environment 311 may indicate that other application 103A-D or operation belonging to the same test run has operated on the dataset before.

In an embodiment, the automated testing system 301 may select the created data as a part of the current test. If the staging data does not exist, then the data is selected from the second computing environment 310 (e.g., production location) with the assumption that this is a first test data operation on the given dataset. If the data exists across multiple computing environments, the orchestration layer 302 may smartly merge the datasets leveraging a merge-partition strategy. An example of the merge-partition strategy is further described with reference to FIG. 4.

By way of example, application 103A may initiate a read operation including test context to read data from the production distributed file system 310C. The read operation may pass through the orchestration layer 302 where isolated context may be determined. Isolated context may include an alphanumerical identifier which identifies that set of isolated resources within the automated testing system 301. The read operation may be routed to the production distributed file system 310C and executed to read from dataset A. The isolated context may ensure that subsequent data operations which read data from the dataset A is read data from the isolated computing environment rather than the production distributed file system 310C to minimize potential disruptions to the second computing environment 310. The production external services 310D may transmit the data to a downstream system or computing process.

In an embodiment, the data read from dataset A may be stored within, the isolated distributed file system 304 and associated with the isolated context. For example, subsequent data operations (e.g., staggered operations) within the pipeline 201 may also require access or interactions with dataset A. The isolated context and translated path may be used to identify and locate the location of dataset A within the isolated distributed file system 304. As such storing data from dataset A within the isolated distributed file system 304 may enable subsequent data operations to read and write data from the isolated computing environment rather than the first (e.g., production) computing environment 310.

For example, application 103C may be associated with a subsequent data operation to write data to dataset A. Rather than writing data to dataset A within the second computing environment 310 and potentially disrupting the production instance 310A, the orchestration layer may utilize the redirect service 306 to redirect (e.g., based on the translated path) the data operation to the isolated distributed file system 304 where the write operation may be executed. In this way, the automated testing system 301 may test for data validation and data quality using production data within an isolated computing environment.

The data written to the isolated computing environment may persist for a predefined or dynamically determined time. For instance, the data may be stored for a duration of 3 days, 7, days, 21 days, etc. In an embodiment, the data may be stored until the current test run is completed. In other embodiments, the data may be remotely destroyed based on external communications. For instance, the isolated computing environment which includes the isolated distributed file system 304 and isolated distributed metadata store 305 may be ephemeral and persist only while the new version of software is being tested. Once the software has been tested the isolated computing environment may be destroyed and data may be deleted. In another embodiment, the isolated computing environment may persist for extended periods of time to test facilitate longer testing periods. In such embodiments, data may still be destroyed on a more frequent basis to reduce storage costs and align to applicable data retention policies.

The automated testing system 301 may generate metric data to create an audit trail of the data operations that were performed on production data. For instance, the orchestration layer 302 may generate metric data indicating that data operations that were directed to each of the computing environments. By way of example, metric data may be generating detailing that a read operation read from the first computing environment and a write operation stored with production data in the isolated computing environment. In an embodiment, the metric data may be linked and detail an audit trail of each action or operation performed on the datasets.

The metric data may be transmitted over one or more networks to an audit system 307. The audit system 307 may include an ingestion system 307A, a storage system 307B, and an analytics system 307C to process the metric data. The ingestion system 307A may include software configured to ingest data stream including the metric data. For instance, the ingestion system 307A may include an event streaming platform configured to ingest data streams (e.g., metric data) and process them for storage. The ingestion system 307A may store the metric data within a storage system 307B in a manner that allows for real-time analytics. For example, the storage system 307B may include an OLAP (online analytical processing) database that facilitates instant retrieval of the metric data by an analytics system 307C. The analytics system 307C may include software configured to read the metric data from the storage system 307B and generate data analytics. In an embodiment, the analytics system 307C may visualize the metric data using dashboards, graphs, charts, etc.

FIG. 4 depicts an example dataflow pipeline according to example aspects of the present disclosure. The example dataflow pipeline 400 is described with an example implementation in which an isolated catalog 404 and committer 405 are used to resolve data when there are multiple paths provided by the path translation service 303 for the requested data.

For example, applications 401 may produce data (e.g., write operations, etc.) incrementally and create new datasets over time. In contrast applications 401 may, more frequently, access existing datasets. For instance, read operations can happen across multiple date ranges and broader data. This can result in significantly less data in the isolated computing environment compared to the second computing environment 310, first computing environment 311, etc. In such embodiment, if an application 401 requests to read data from a large number of locations (e.g., across the isolated computing environment, second computing environment 310, first computing environment 311, etc.) conflicts may arise due to the availability of certain locations across these locations.

By way of example, an application 401 (e.g., applications 103A-F, etc.) may request (e.g., read operation) to interact with a dataset by way of a data operation 402. The data operation 402 may include a command written in a database language such as DDL (data definition language), DQL (data query language), DML (data manipulation language), etc. In an embodiment, the automated testing system 301 may parse the query (e.g., database commands, etc.) initiated by the applications to determine metadata associated with the intended datasets. For instance, the isolated metadata 305 store may store metadata which allows for faster searching and querying of the various datasets. The metadata and be used in addition to the catalog to read and write operations more efficiently.

In an embodiment, all the interactions with the datasets may pass through the isolated catalog 404. For instance, the isolated catalog may validate write operations and govern read operations using the path translation service 303.

In an embodiment, the isolated catalog 404 may include functionality similar to that of the catalog associated with the pipeline (e.g., pipelines 201, 201A-B, etc.) acting as a registry for locations of datasets stored within the isolated distributed file system 304. In an embodiment, the isolated catalog 404 may provide programmatic (e.g., API, scripting, etc.) access to create new locations (e.g., tables, etc.) within the isolated distributed file system 304. In an embodiment, the isolated catalog 404 may also serve as a checkpoint to ensure that only one isolated computing environment associated with the isolated context is running at once. In another embodiment, the isolated catalog 404 may also prevent any write operations within the second computing environment 310. For instance, the isolated catalog 404 may provide API access to create additional tables within the isolated distributed file system 304. The isolated catalog may be updated to include the newly created (e.g., via the API request) locations within the distributed file system 304 and direct request to the newly created isolated location.

The isolated catalog 404 may determine the read operation is associated with paths across multiple computing environments (e.g., second computing environment 310, first computing environment 311, etc.) and may implement a merge-partition strategy. The merge-partition strategy includes policies where conflicting paths are given preference to sub-production environments and the remaining data is read from production environments. Data read from disparate data partitions (e.g., blocks of data within datasets) may be merged intelligently together to execute the read operation.

In some embodiments, applications 401 may provide the locations of data explicitly. For example, data operations which do not go through isolated catalog 404 may be executed directly using the defined paths. For instance, the path translation service 303 may communicate with the committer layer 405. The committer layer 405 may include software configured to serve as an additional measure to ensure that all datasets associated with write operations is committed to isolated locations (e.g., within the distributed file system 304). If the committer layer 405 encounters a write request operation where the location is explicitly defined (e.g., defined programmatically) for a non-isolated location (e.g., second computing environment 310, first computing environment 311, etc.), the committer layer 405 may retrieve the new path from the path translator service 303 and either execute the write operation using the updated path (e.g., to a newly created isolated location associated) or dismiss the operation. The updated locations may also be updated within the isolated metadata store 305. For instance, metadata associated with the isolated locations within the isolated distributed data file system 304 may be updated to reflect new isolated locations for faster retrieval of data for subsequent data operations.

In an embodiment, an RDD (resilient distributed dataset) 403 may be used perform data operations from the application 401. For example, RDD 403 calls may be sent directly to the committer 405 bypassing the isolated catalog 404. An RDD 403 may include an immutable distributed collection of datasets partitioned across a set of nodes of a cluster (e.g., within a computing environment) that can be recovered if a partition is lost. In an embodiment, an RDD 403 may provide fault tolerance coverage in the event of a disruption. In another embodiment, RDD 403 may also provide in-built memory computing and allow for referencing datasets stored in external storage systems (e.g., production distributed file system 310C, sub-production distributed file system 311C, etc.).

By way of example, in an implementation where the isolated catalog 404 is not enabled, the orchestration layer 302 may utilize path translations from the path translation service 303 and the RDD 403 completely for directing read and write operations. In this example embodiment, the committer layer 405, before executing writing operations may check the path translation service 303 to read from the location specified from by the path and write to the updated isolated locations specified by the path using the RDD 403. As such read operations may be performed based on the output given from path translation (e.g., at the isolated location).

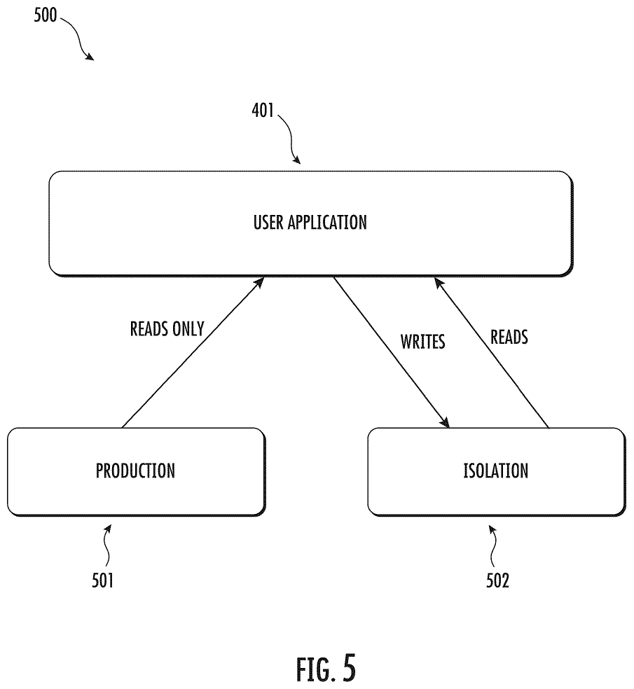

FIG. 5 depicts an example data flow pipeline according to example aspects of the present disclosure. The example dataflow pipeline 500 is described with an example implementation in which an application 401 testing a new version of software reads from a production dataset 501, processes the data and writes to an isolated dataset 502. The production dataset 501 may include one or more dataset locations within in the second computing environment 310. For instance, the production dataset 501 may be associated with a production data location in a production environment. The isolated dataset 502 may include one or more dataset locations within the isolated computing environment (e.g., isolated distributed file system 304). For instance, the isolated dataset 502 may be associated with an isolated location determined by the automated testing system 301.

The example dataflow pipeline 500 depicts a simple testing flow that may occur with a single application 401. For instance, in the example embodiment, since both the production dataset 501 and the isolated dataset 502 locations exist, the read operation may be executed against the production datasets 501. The application 401 may receive the requested data in response to the read operation.

In an embodiment, the application 401 may process the data. Processing the data may include performing one or more actions on the data to update, transform, or otherwise manipulate the data. By way of example, the application 401 may combine the retrieved data with other datasets and generate forecast data (e.g., forecasted financials, resources, etc.). The application 401 may subsequently write the forecast data to the isolated dataset 502. For example, the test context may indicate that the application is 401 is executing a test run to test a new version of software. As such the application 401 reads and process the production dataset 501, but may write the output into the isolated dataset where the data may be validated.

Validating the isolated dataset 502 may include comparing the isolated dataset 502 (e.g., second dataset) to a dataset within the second computing environment 310. For example, the application 401 may run in parallel instances where an implemented (e.g., current) version of software is running and executing the same read and write operations against the production dataset 501. The write operations from the application 401 running within the production instance (e.g., production instance 310A) may produce a production forecast dataset that is stored in the second computing environment 310. In order to perform data validation and data quality testing, the isolated dataset 502 may be compared to the output data written to the second computing environment 310. Comparing the isolated dataset and the output data written to the second computing environment 310 (e.g., dataset associated with the implemented version) the automated testing system 301 may identify potential errors that may arise once the new version is deployed within the first computing environment.

Example errors may include corrupted data (e.g., unintended changes to the data), duplicate data (e.g., over writing data with duplicate values), data formatting (e.g., incorrectly formatted data), or any other type of data quality error. In an embodiment, the audit computing system 307 may receive metric data indicating the errors resulting from the test run and transmit error data describing the error to a remote computing system. By way of example, the automated testing system 301 may detect a data corruption error by comparing the isolated dataset with the dataset output within the second computing environment 310 and generate a metric data indicating the error. The metric data may be processed by the audit computing system 307 and a notification may be sent to an administrator or custodian of the application 401 indicating the error that occurred during testing. In an embodiment the notification may be an email notification, a messaging notification, or an API request. For instance, the audit computing system 307 may transmit an API request to a software project management tool, ticketing system, etc. to create task to address the error. In an embodiment, a workflow may be facilitated through the detection of errors, where pending or unresolved errors prevent the test version of the software from being deployed within the second computing environment 310.

In another embodiment, the automated testing system 301 may utilize the audit computing system to perform additional monitoring and certification of the application post deployment to the second computing environment 310. Certification may include determining the deployed version (e.g., new version, version with new changes, etc.) causes no issues over a threshold period of time (e.g., one hour, one day, one week, etc.). By way of example, the automated testing system 301 may monitor read and write operations performed against the production dataset 501 and monitor for computing errors (e.g., bugs, etc.) or data quality errors (e.g., corrupted data etc.). Monitoring may occur for a threshold period of time. For instance, monitoring periods may be shorted for applications (e.g., application 401) which execute a high rate of read and write operations. In an embodiment, monitoring may occur for a threshold number (e.g., 100, 1,000, etc.) of successful read and write operations. Metric data may be captured for the read and write operations executed within the second computing environment 310. If errors occur within the monitoring period, the automated testing system 301 may rollback to the previous version (e.g., originally implemented version) and perform additional testing.

For example, the automated testing system 301 may redeploy the previously implemented version of the software within the second computing environment 310 and re-test the failed read and/or write operations within the isolated computing environment. For instance, the automated testing system 301 may execute additional test runs to isolate the root cause of the errors displayed within the second computing environment 310. In some embodiments, the automated testing system 301 may also transmit one or more notifications to the application owner (e.g., custodian, etc.) to indicate the errors occurring in production. In other embodiments, the performance of the application 401 (e.g., metrics data, etc.) may be visualized (e.g., dashboards, graphics, etc.) to display application performance, application health, data quality scores, code quality reports, etc.) Once all errors have been resolved, the automated testing system 301 may redeploy (e.g., migrate, merge branches, etc.) the new version of software to the second computing environment 310. Once the application 401 runs without errors for the duration of the monitoring period, the automated testing system 301 may certify the new version of the software.

The application 401 may additionally perform a read operation on the isolated dataset 502. For instance, the application 401 may subsequently read the forecast data it generated for a separate purpose. By way of example, a historical data analysis trend may be generated for financials, resources, etc. and the previously generated forecast data stored in the isolated dataset 502 may be needed to test the functionality of generating such historical data analysis running the new version of the software. As such the application 401 may read from the isolated dataset 502 and further process the forecast data.

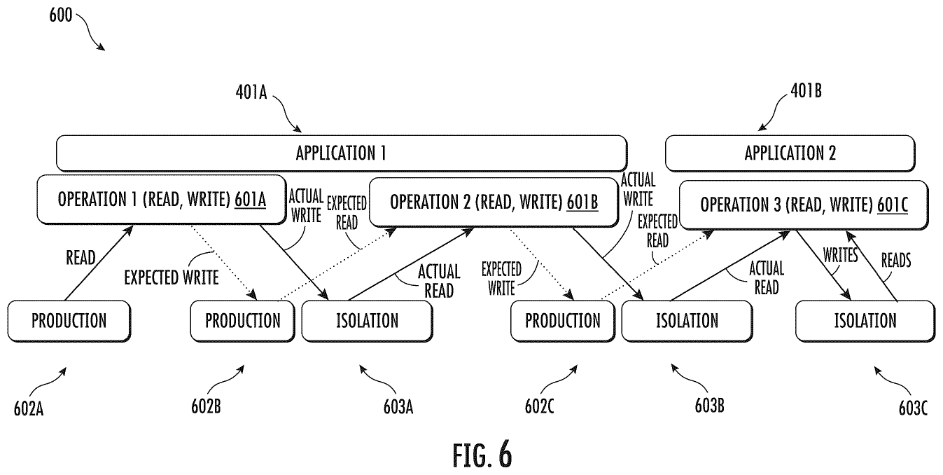

In an embodiment, the automated testing system 301 may ensure that all data operations associated with test context (e.g., a test tun) always perform writing operations with the isolated dataset 502. This ensures that there are no adverse impacts to the first computing environment 311. In an embodiment, a plurality of applications 401 may perform read and write operations against a plurality of isolated datasets 502. An example of a plurality of applications performing read and write operations against a plurality of isolated datasets 502 is further described with reference to FIG. 6.

FIG. 6 depicts a dataflow pipeline to example aspects of the present disclosure. The dataflow pipeline 600 depicts an example dataflow pipeline within an example implementation in which multiple applications 401A-B perform read and write operations 601A-C against multiple production datasets 602A-C and multiple isolated environments 603A-C. While examples herein describe two applications 401A-B, three sets of read and write operations 601A-C, and two sets of production datasets 602A-C and multiple isolated environments 603A-C respectively, the present disclosure is not limited to such embodiment. The technology of the present disclosure may be applied to hundreds or thousands of applications executing hundreds of thousands of read and write operations 601A-C against hundreds of thousands production datasets 602A-C and multiple isolated environments 603A-C respectively.

As depicted in dataflow pipeline 600, applications 401A-B may perform read and write operations 601A-C to interact with multiple datasets. In an embodiment the applications 401A-B may be included within a single pipeline (e.g., pipeline 201, etc.). In an embodiment, the applications 401A-B may be associated with different pipelines (e.g., 201A-B, etc.) For instance, the isolated context generated by the automated testing system 301 may provide visibility to the isolated dataset written to by application 401A such that application 401A may perform read operations against it.

By way of example, application 401A may perform read and write operations 601 to read data from a first production dataset 602A. For instance, application 401A may read incident data indicating information regarding network or computing incidents over a given period (e.g., associated with the enterprise computing system 101, etc.). The application 401A may process the first production dataset 602A including the incident data and derive possible root causes of the incidents. Test context may be associated with the read and write operations 401A indicating that the application is executing a test run of software changes, new version, etc. Accordingly, application 601A may not write to a second production dataset 602B and instead perform a write operation to write the root cause data to a first isolate dataset 603A. In an embodiment isolated context (e.g., isolated context property) may identify the first isolated dataset 603A and the associated test context such that subsequent data operations (e.g., read and write operations 601B-C) may perform data operations against the first isolated dataset irrespective of whether those data operations are contained within the same pipeline.

In an embodiment, the application 401A may subsequently perform read and write operations 601B against the first isolated data set 603A. For example, the application 401A may read the root cause data from the first isolated dataset 603A and process it to determine what subset of systems are adversely affected by incidents. In an embodiment, the application 401A may generate system level incident data indicating specific systems adversely impacted by incidents. As such the application 401 may write to a second isolated dataset 603B. For instance, the read and write operations 601B may be associated with the same test context and indicate the same isolated context. In response to detecting the test context and the isolated context, the application 401A may not write to a second production dataset 602C, but rather a second isolated dataset 603B due to the read and write operation 601B being associated with a test run to test software changes, new versions, etc.

In an embodiment, application 401B may also perform read and write operations 601C against production and isolated datasets. For instance, application 401B may perform a read operation to read the system specific incident data from the second isolated dataset. For instance, the read operation may indicate the same test context and isolated context. The application 401B may process the system specific incident data and generate geographic incident data. For example, additional data analytics may be performed on the system specific incident data to determine what geographic areas are most impacted by the system specific incidents. The geographic system specific incident data may be written to a third isolated dataset 603C where it may be stored for a period of time or subsequently accessed by the application 401B or other downstream systems.

In an embodiment, the test run may terminate when respective applications 401A-B, pipelines, etc. complete its series of read and write operations 601A-C. For example, the geographic system specific incident data stored within the third isolated dataset 603C may not be accessed for a threshold period of time. Once the threshold period of time has been reached, data retention policies governing the isolated datasets 603A-C may cause the data to be deleted (e.g., wiped, destroyed, etc.) In this way new test runs may be executed if additional changes (e.g., code changes, bug fixes, etc.) are made. Additionally, deleting the data within the isolated datasets 603A-C may reduce storage costs for the isolated testing system 301.

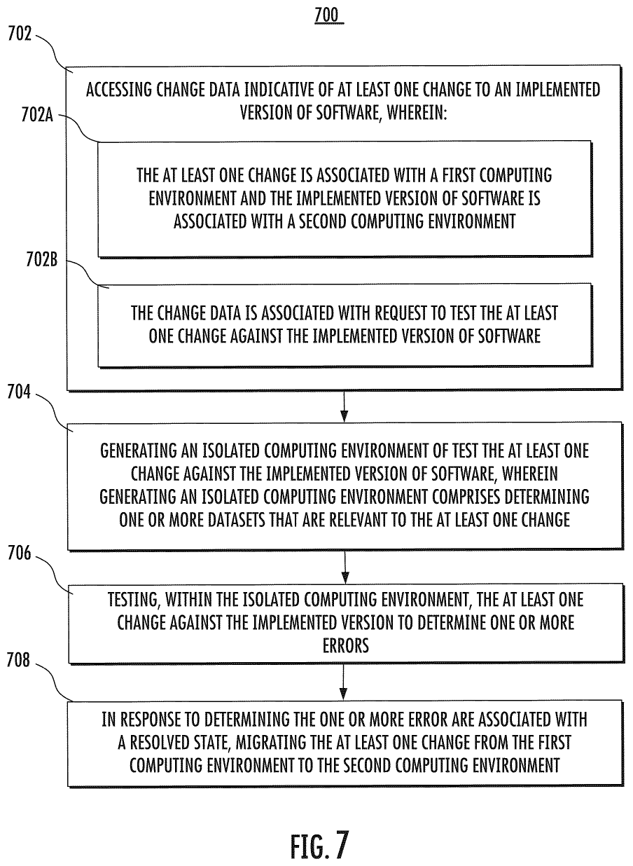

FIG. 7 depicts a flowchart diagram of an example method according to example aspects of the present disclosure. One or more portion(s) of the method 700 may be implemented by one or more computing devices such as, for example, the computing devices/systems described in FIGS. 1, 2, 3, 4, 5, 6, etc. Moreover, one or more portion(s) of the method 700 may be implemented as an algorithm on the hardware components of the device(s) described herein. For example, a computing system may include one or more processors and one or more non-transitory, computer-readable media storing instructions that are executable by the one or more processors to cause the computing system to perform operations, the operations including one or more of the operations/portions of method 700. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

In an embodiment, the method 700 may include a step 702 or otherwise begin by accessing change data indicative of at least one change to an implemented version of software. For instance, the application compute service 102 may control the versions of enterprise application software 102A-D that are available to the applications 103A-F. By way of example, the application compute service 102 may be used to update enterprise application software 102B (e.g., data analytics software) to newer versions. For instance, a new version of the data analytics software may be released in open-source or otherwise become available. The new version may be staged for testing within a sub-production (e.g., first) computing environment for testing.

In some embodiments, staging the new version or changes to the data analytics software may generate change data indicating a change to the currently implemented version. For example, test context may be manually generated (e.g., by a system custodian, administrator, etc.) or programmatically generated e.g., (API requests, pull requests, etc.).

In an embodiment, the step 702 may include step 702A, wherein (i) the at least one change is associated with a first computing environment and the implemented version of software is associated with a second computing environment. For instance, the new version of the data analytics software may be staged within the first computing environment 311 (e.g., sub-production environment). The first computing environment 311 may include a sub-production instance 311A, a sub-production distributed metadata store 311B, a sub-production distributed file system 311C, and sub-production services 311D associated with the data analytics software. The first computing environment 311 may include the new or untested version of the data analytics software.

For instance, the new versions of software or software changes may need to be tested prior to being deployed within a production (e.g., second computing environment 310). As such, the first computing environment 311 may be used to test codes, builds, and updates of the data analytics software to ensure quality under a “production-like” environment before application deployment.

The second computing environment 310 may be associated with a production version (e.g., currently implemented version) of the data analytics software. For instance, the second computing environment 310 may include a production instance 310A, a production distributed metadata store 310B, a production distributed file system 310C, and production services 310D associated with the data analytics software.

In an embodiment, the step 702 may include step 702A, wherein (ii) the change data is associated with a request to test the at least one change against the implemented version of software. For instance, the test context (e.g., change data) may indicate the one or more portions of the enterprise application software 103A-D which are affected or changed. The test context may be injected or otherwise associated with the applications 103A-d within a pipeline 201 and indicate to the automated testing system 301 that the read and write operations 601A-C are associated with a test run.

By way of example, the test context may trigger the automated testing system 301 to simulate testing for the associated read and write operations 601A-C by running an instance of the new (e.g., untested) version of the data analytics software, performing the read and write with the new version and writing to an isolated computing environment. Simulating read and write operations 601A-C using the new version of the data analytics software and writing to the isolated computing environment may allow for data validation and quality testing without impacting production.

In an embodiment, the method 700 may include a step 704 or otherwise continue by generating an isolated computing environment to test the at least one change against the implemented version of software, wherein generating an isolated computing environment includes determining one or more datasets that are relevant to the at least one change. For instance, the test context (e.g., change data) may indicate the new version of the data analytics software that is being initialized for a test run within the pipeline 201. In response to the test context, the orchestration layer 302 may provision an isolated computing environment which runs an instance of the new version of the data analytics software. The isolated computing environment may include a private client or server device which restricts external access.

For example, the isolated computing environment may include an isolated distributed file system 304 and an isolated metadata store 305 which runs the new version of the data analytics software and stores resulting data from the simulated data operations that have passed through the orchestration layer 302. In an embodiment, the first computing environment 311 may also host the new version of the data analytics software. For instance, an isolated computing environment (e.g. private client, etc.) may be provisioned which is separate from the sub-production instance 311A, but within the first computing environment 311. The new version of the data analytics software may be run within the first computing environment 311 (e.g., private client, etc.) and data operations may be stored within the isolated computing environment (e.g., isolated distributed file system 304) to preserve the integrity of the data.

In an embodiment, a catalog may be accessed which includes a registry of a locations of datasets which are accessed within a pipeline (e.g., pipelines 201, 201A-B, etc.). For instance, a pipeline may perform read and write operations 601A-C in a staggered manner. As such the pipelines may read from a catalog to determine datasets which are relevant to the current test run. By way of example, a pipeline 201A may include applications 103A and 103B. The catalog may indicate that applications 103A-B will perform read and write operations 601A-C against datasets 202A-B. As such the pipeline 201A may stagger the data operations between the applications 103A-B.

In an embodiment, the automated testing system 301 may also access the catalog to determine where data should be written when executing a test run. For example, application 103A may read data from a first production dataset (e.g., first production dataset 602A) and process it. Instead of writing the output data to a second production dataset 602B, the automated testing system 301 may write the data to a first isolated dataset (e.g., first isolated dataset 603A) based on determining (e.g., from the catalog) the expected location of the write operation.

In an embodiment, the isolated catalog 404 may include functionality similar to that of the catalog associated with the pipeline (e.g., pipelines 201, 201A-B, etc.) acting as a registry for locations of datasets stored within the isolated distributed file system 304. In an embodiment, the isolated catalog 404 may provide programmatic (e.g., API, scripting, etc.) access to create new locations (e.g., tables, etc.) within the isolated distributed file system 304. In an embodiment, the isolated catalog may be updated to include the newly created (e.g., via the API request) locations within the distributed file system 304 and direct request to the newly created isolated location.

The isolated catalog 404 may determine the read operation is associated with paths across multiple computing environments (e.g., second computing environment 310, first computing environment 311, etc.) and may implement a merge-partition strategy. The merge-partition strategy includes policies where conflicting paths are given preference to sub-production environments and the remaining data is read from production environments. Data read from disparate data partitions (e.g., blocks of data within datasets) may be merged intelligently together to execute the read operation.

In an embodiment, the method 700 may include a step 706 or otherwise continue by testing, within the isolated computing environment, the at least one change against the implemented version of software. For instance, the read and write operations 601A-C may be executed against intended datasets, processed, and written to an isolated computing environment. By way of example, the applications 102A-B may read data from a dataset, process it, and write it to an isolated dataset. As the applications 102A-B execute the new version of the data analytics software, perform read and write operations 601A-C, etc. the audit system 307 may receive metric data indicating errors that have occurred. The errors may be communicated to a remote computing system or pausing the test run until they are addressed.

In an embodiment, testing may include validating the data written to the isolated computing environment. Validating the isolated dataset 502 may include comparing the isolated dataset 502 (e.g., second dataset) to a dataset within the second computing environment 310. For example, the application 401 may run in parallel instances where an implemented (e.g., current) version of software is running and executing the same read and write operations against the production dataset 501. The write operations from the application 401 running within the production instance (e.g., production instance 310A) may produce a production forecast dataset that is stored in the second computing environment 310. In order to perform data validation and data quality testing, the isolated dataset 502 may be compared to the output data written to the second computing environment 310. Comparing the isolated dataset and the output data written to the second computing environment 310 (e.g., dataset associated with the implemented version) the automated testing system 301 may identify potential errors that may arise once the new version is deployed within the first computing environment.

In an embodiment, the method 700 may include a step 708 or otherwise continue by migrating the at least one change from the first computing environment to the second computing environment. For instance, the automated testing system 301 may determine (e.g., based on metric data) that there are no pending errors associated with the test run. The pending errors may include software bugs or data validation/quality errors. Upon determining no errors are present, the automated testing system may trigger a deployment of the new version of the data analytics software into the second computing environment. Triggering a deployment may include merging a pull request (e.g., migrating code to a base branch), triggering a CI/CD (continuous integration, continuous delivery) pipeline to deploy the code in production, generating a task to manually migrate or update the current version to the new version, etc. a

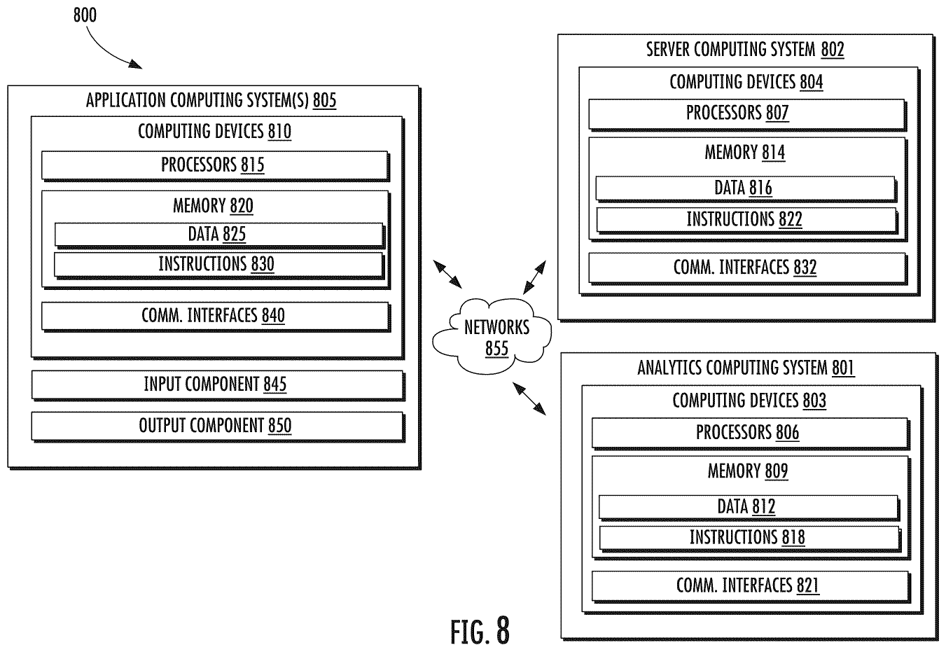

FIG. 8 depicts a block diagram of an example system 800 for implementing systems and methods according to example embodiments of the present disclosure. The example system 800 illustrated in FIG. 8 is provided as an example only. The components, systems, connections, and/or other aspects illustrated in FIG. 8 are optional and are provided as examples of what is possible, but not required, to implement the present disclosure. The example system 800 can include an application computing system 805 (e.g., applications 103A-F, application 401, etc.). The example system 800 can include a server computing system 802 (e.g., enterprise computing system 101, etc.). The example system 800 can include an analytics computing system 801 (e.g., analytical computing system 307, etc.). One or more of the application computing systems 805, the server computing system 802, or the analytics computing system 801 can be communicatively coupled to one another over one or more communication network(s) 855. The networks 855 can correspond to any of the networks described herein.

The computing device(s) 810 of the application computing system 805 can include processor(s) 815 and a memory 820. The one or more processors 815 can be any suitable processing device (e.g., a processor core, a microprocessor, an ASIC, a FPGA, a controller, a microcontroller, etc.) and can be one processor or a plurality of processors that are operatively connected. The memory 820 can include one or more non-transitory computer-readable storage media, such as RAM, ROM, EEPROM, EPROM, one or more memory devices, flash memory devices, data registrar, etc., and combinations thereof.

The memory 820 can store information that can be accessed by the one or more processors 815. For example, the memory 820 (e.g., one or more non-transitory computer-readable storage mediums, memory devices, etc.) can include computer-readable instructions 1330A that can be executed by the one or more processors 815. The instructions 830 can be software written in any suitable programming language or can be implemented in hardware. Additionally, or alternatively, the instructions 830 can be executed in logically and/or virtually separate threads on processor(s) 815.

For example, the memory 820 can store instructions 830 that when executed by the one or more processors 815 cause the one or more processors 815 (e.g., of the application computing system 805, etc.) to perform operations such as any of the operations and functions of the computing system(s) (e.g., operations computing system, etc.) described herein (or for which the system(s) are configured), one or more of the operations and functions for communicating between the computing systems, one or more portions/operations of method 700, and/or one or more of the other operations and functions of the computing systems described herein.

The memory 820 can store processors 815 that can be obtained (e.g., acquired, received, retrieved, accessed, created, stored, etc.). The data 825 can include, for example, any of the data/information described herein. In some implementations, the computing device(s) 810 can obtain data from one or more memories that are remote from the application computing system 805.

The computing device(s) 805 can also include a communication interface 840 used to communicate with one or more other system(s) remote from the application computing system 805, such as server computing system 802, and/or the analytics computing system 801. The communication interface 840 can include any circuits, components, software, etc. for communicating via one or more networks (e.g., network(s) 855, etc.). The communication interface 840 can include, for example, one or more of a communications controller, receiver, transceiver, transmitter, port, conductors, software and/or hardware for communicating data.

The server computing system 802 can include one or more computing device(s) 804 that are remote from the application computing system 805 and the analytics computing system 801. The computing device(s) 804 can include one or more processors 807 and a memory 814. The one or more processors 807 can be any suitable processing device (e.g., a processor core, a microprocessor, an ASIC, a FPGA, a controller, a microcontroller, etc.) and can be one processor or a plurality of processors that are operatively connected. The memory 814 can include one or more tangible, non-transitory computer-readable storage media, such as RAM, ROM, EEPROM, EPROM, one or more memory devices, flash memory devices, data registrar, etc., and combinations thereof.

The memory 814 can store information that can be accessed by the one or more processors 807. For example, the memory 814 (e.g., one or more tangible, non-transitory computer-readable storage media, one or more memory devices, etc.) can include computer-readable instructions 822 that can be executed by the one or more processors 807. The instructions 822 can be software written in any suitable programming language or can be implemented in hardware. Additionally, or alternatively, the instructions 822 can be executed in logically and/or virtually separate threads on processor(s) 807.

For example, the memory 814 can store instructions 822 that when executed by the one or more processors 807 cause the one or more processors 807 to perform operations such as any of the operations and functions of the computing system(s) (e.g., advertisement server, etc.) described herein (or for which the system(s) are configured), one or more of the operations and functions for communicating between computing systems, one or more portions/operations of method 700 and/or one or more of the other operations and functions of the computing systems described herein. The memory 814 can store data 816 that can be obtained. The data 816 can include, for example, any of the data/information described herein.

The computing device(s) 804 can also include a communication interface 832 used to communicate with one or more system(s) that are remote from the system 802. The communication interface 832 can include any circuits, components, software, etc. for communicating via one or more networks (e.g., network(s) 855, etc.). The communication interface 832 can include, for example, one or more of a communications controller, receiver, transceiver, transmitter, port, conductors, software and/or hardware for communicating data.

The analytics computing system 801 can include one or more computing device(s) 803 that are remote from the application computing system 805 and the server computing system 802. The computing device(s) 803 can include one or more processors 806 and a memory 809. The one or more processors 806 can be any suitable processing device (e.g., a processor core, a microprocessor, an ASIC, a FPGA, a controller, a microcontroller, etc.) and can be one processor or a plurality of processors that are operatively connected. The memory 809 can include one or more tangible, non-transitory computer-readable storage media, such as RAM, ROM, EEPROM, EPROM, one or more memory devices, flash memory devices, data registrar, etc., and combinations thereof.

The memory 809 can store information that can be accessed by the one or more processors 806. For example, the memory 809 (e.g., one or more tangible, non-transitory computer-readable storage media, one or more memory devices, etc.) can include computer-readable instructions 818 that can be executed by the one or more processors 806. The instructions 818 can be software written in any suitable programming language or can be implemented in hardware. Additionally, or alternatively, the instructions 818 can be executed in logically and/or virtually separate threads on processor(s) 806.

For example, the memory 809 can store instructions 818 that when executed by the one or more processors 806 cause the one or more processors 806 to perform operations such as any of the operations and functions of the computing system(s) (e.g., user devices, etc.) described herein (or for which the user device(s) are configured), one or more of the operations and functions for communicating between systems, one or more portions/operations of method 700 and/or one or more of the other operations and functions of the computing systems described herein. The memory 809 can store data 812 that can be obtained. The data 812 can include, for example, any of the data/information described herein.

The computing device(s) 803 can also include a communication interface 821 used to communicate computing device/system that is remote from the analytics computing system 801, such as server computing system 802 or application computing system 805. The communication interface 821 can include any circuits, components, software, etc. for communicating via one or more networks (e.g., network(s) 855, etc.). The communication interface 821 can include, for example, one or more of a communications controller, receiver, transceiver, transmitter, port, conductors, software and/or hardware for communicating data.

The network(s) 855 can be any type of network or combination of networks that allows for communication between devices. In some implementations, the network(s) 855 can include one or more of a local area network, wide area network, the Internet, secure network, cellular network, mesh network, peer-to-peer communication link and/or some combination thereof and can include any number of wired or wireless links. Communication over the network(s) 855 can be accomplished, for example, via a communication interface using any type of protocol, protection scheme, encoding, format, packaging, etc.

Computing tasks discussed herein as being performed at certain computing device(s)/systems may instead be performed at another computing device/system, or vice versa. Such configurations may be implemented without deviating from the scope of the present disclosure. The use of computer-based systems allows for a great variety of possible configurations, combinations, and divisions of tasks and functionality between and among components. Computer-implemented operations may be performed on a single component or across multiple components. Computer-implemented tasks or operations may be performed sequentially or in parallel. Data and instructions may be stored in a single memory device or across multiple memory devices.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination. Databases and applications may be implemented on a single system or distributed across multiple systems. Distributed components may operate sequentially or in parallel.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. The term “or” and “and/or” may be used interchangeably herein. Lists joined by a particular conjunction such as “or,” for example, may refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims discussed herein may be adapted, rearranged, expanded, omitted, combined, or modified in various ways without deviating from the scope of the present disclosure. Some implementations are described with a reference numeral, for example illustrated purposes and are not meant to be limiting.

What is claimed is:

1. A computer-implemented method comprising:
accessing change data indicative of at least one change to an implemented version of software, wherein:
(i) the at least one change is associated with a first computing environment and the implemented version of software is associated with a second computing environment, and
(ii) the change data is associated with a request to test the at least one change against the implemented version of software;
generating an isolated computing environment to test the at least one change against the implemented version of software, wherein generating an isolated computing environment comprises determining one or more datasets that are relevant to the at least one change;
testing, within the isolated computing environment, the at least one change against the implemented version of software; and
migrating the at least one change from the first computing environment to the second computing environment.

2. The computer-implemented method of claim 1, wherein generating an isolated computing environment comprises:
determining a plurality of applications associated with the at least one change, wherein at least one application of the plurality of applications is directly impacted by the at least one change.

3. The computer-implemented method of claim 2, wherein the plurality of applications associated with the at least one change are associated with at least one of: (i) input data inputted into the at least one application or (ii) output data produced by the at least one application.

4. The computer-implemented method of claim 1, wherein determining one or more datasets comprises:
accessing a catalog comprising information indicative of at least one of: (i) a read operation to read data, or (ii) a write operation to write data to at least one location associated with a dataset.

5. The computer-implemented method of claim 1, further comprising:
parsing one or more queries associated with the one or more datasets to determine metadata associated with one or more data operations that interact with the one or more datasets.

6. The computer-implemented method of claim 1, wherein testing within the isolated computing environment comprises:
executing at least a portion of the at least one change and the implemented version of software to perform at least one of: (i) read data from a first dataset, (ii) process data from the first dataset, or (iii) write data to a second dataset.

7. The computer-implemented method of claim 6, further comprising:
validating the data written to the second dataset by comparing the second dataset to a previous dataset associated with the implemented version of software.

8. The computer-implemented method of claim 6, wherein the second dataset is ephemerally stored within the isolated computing environment.

9. The computer-implemented method of claim 6, wherein the second dataset is associated with a context identifier, wherein the context identifier identifies the second dataset for subsequent testing requests.

10. The computer-implemented method of claim 9, further comprising:
receiving one or more subsequent requests to test a change associated with the second dataset; and
executing at least a portion of the change associated with the second dataset to read data from the second dataset.

11. The computer-implemented method of claim 1, further comprising:
generating metric data associated with a performance of the at least one change, the metric data indicative of at least one of: (i) computing efficiencies or (ii) new features generated as a result of migrating the at least one change to the second computing environment.

12. The computer-implemented method of claim 1, further comprising:
in response to testing the at least one change, detecting an error; and
transmitting error data describing the error to a remote computing system.

13. A computing system comprising:
one or more processors; and
one or more non-transitory computer-readable medium storing instructions that are executable by one or more processors to cause the computing system to perform operations, the operations comprising:
accessing change data indicative of at least one change to an implemented version of software, wherein:
(i) the at least one change is associated with a first computing environment and the implemented version of software is associated with a second computing environment, and
(ii) the change data is associated with a request to test the at least one change against the implemented version of software;
generating an isolated computing environment to test the at least one change against the implemented version of software, wherein generating an isolated computing environment comprises determining one or more datasets that are relevant to the at least one change;
testing, within the isolated computing environment, the at least one change against the implemented version of software; and
migrating the at least one change from the first computing environment to the second computing environment.

14. The computing system of claim 13, wherein generating an isolated computing environment comprises:
determining a plurality of applications associated with the at least one change, wherein at least one application of the plurality of applications is directly impacted by the at least one change.

15. The computing system of claim 14, wherein the plurality of applications associated with the at least one change are associated with at least one of: (i) input data inputted into the at least one application or (ii) output data produced by the at least one application.

16. The computing system of claim 13, wherein determining one or more datasets comprises:
accessing a catalog comprising information indicative of at least one of: (i) a read operation to read data, or (ii) a write operation to write data to at least one location associated with a dataset.

17. The computing system of claim 13, wherein the operations further comprise:
parsing one or more queries associated with the one or more datasets to determine metadata associated with one or more data operations that interact with the one or more datasets.

18. The computing system of claim 13, wherein testing within the isolated computing environment comprises:
executing at least a portion of the at least one change and the implemented version of software to perform at least one of: (i) read data from a first dataset, (ii) process data from the first dataset, or (iii) write data to a second dataset.

19. The computing system of claim 18, wherein the operations further comprise:
validating the data written to the second dataset by comparing the second dataset to a previous dataset associated with the implemented version of software.

20. A non-transitory computer-readable medium storing instructions that are executable by one or more processors to perform operations, the operations comprising:
accessing change data indicative of at least one change to an implemented version of software, wherein:
(i) the at least one change is associated with a first computing environment and the implemented version of software is associated with a second computing environment, and
(ii) the change data is associated with a request to test the at least one change against the implemented version of software;
generating an isolated computing environment to test the at least one change against the implemented version of software, wherein generating an isolated computing environment comprises determining one or more datasets that are relevant to the at least one change;
testing, within the isolated computing environment, the at least one change against the implemented version of software; and
migrating the at least one change from the first computing environment to the second computing environment.
